(19) United States
(12) Patent Application Publication
(10) Pub. No.: US 2025/0381780 A1
(43) Pub. Date: Dec. 18, 2025

(54) PRINTING APPARATUS, CONTROL METHOD THEREFOR, AND NON-TRANSITORY COMPUTER-READABLE STORAGE MEDIUM

(71) Applicant: CANON KABUSHIKI KAISHA, Tokyo (JP)

(72) Inventor: YOHEI OMORI, Kanagawa (JP)

(21) Appl. No.: 19/234,016

(22) Filed: Jun. 10, 2025

(30) Foreign Application Priority Data
Jun. 12, 2024 (JP) 2024-095375

(51) Int. Cl. B41J 2/165; B41J 11/00; B41J 11/66; B41J 11/70; B41J 25/00

(52) U.S. Cl. CPC B41J 2/16505; B41J 11/0095; B41J 11/663; B41J 11/70; B41J 25/001

(57) ABSTRACT

A printing apparatus, comprising a printing head that performs printing on a printing medium, a conveyance mechanism that conveys a printing medium, a maintenance unit that executes a maintenance operation for the printing head, and a control unit, wherein the maintenance unit is configured to be able to receive power in the conveyance mechanism and to be able to perform the maintenance operation based on the received power, and the control unit determines existence or absence of a printing medium in the conveyance mechanism and a state of the maintenance unit when the printing apparatus is started up, and decides permission/inhibition of execution of a first initialization operation of initializing the conveyance mechanism and the maintenance unit based on a result of the determination.

### BACKGROUND

### Field of the Technology

The present disclosure relates to a printing apparatus.

### Description of the Related Art

Patent Document 1 describes a technique of shortening start-up time without initializing a part of elements included in a printing apparatus when the printing apparatus is started up by being powered on (see Japanese Patent Laid-Open No. 2016-36941).

Some printing apparatuses include a maintenance unit that performs maintenance of a printing head using power of a conveyance mechanism for conveying a printing medium. Even such a configuration requires a technique of appropriately shortening start-up time of the printing apparatus.

### SUMMARY

The present disclosure provides an advantageous technique of appropriately shortening start-up time of the printing apparatus.

One of the aspects of the present disclosure provides a printing apparatus comprising: a printing head that performs printing on a printing medium; a conveyance mechanism that conveys a printing medium; a maintenance unit that executes a maintenance operation for the printing head, the maintenance unit being configured to be able to receive power in the conveyance mechanism and to be able to perform the maintenance operation based on the received power; and a control unit configured to determine existence or absence of a printing medium in the conveyance mechanism and a state of the maintenance unit when the printing apparatus is started up, and decides permission/inhibition of execution of a first initialization operation of initializing the conveyance mechanism and the maintenance unit based on a result of the determination.

Features of the present disclosure will become apparent from the following description of embodiments with reference to the attached drawings. The following description of embodiments are described by way of example.

### BRIEF DESCRIPTION OF THE DRAWINGS

FIG. 1 is a block diagram illustrating an example of a system configuration of a printing apparatus according to an embodiment.

FIG. 2A, FIG. 2B, and FIG. 2C are schematic side views illustrating an example of an internal configuration of the printing apparatus.

FIG. 3 is a schematic top view illustrating an example of the internal configuration of the printing apparatus.

FIG. 4A, FIG. 4B, FIG. 4C, and FIG. 4D are schematic side views illustrating an example of a configuration of a maintenance unit.

FIG. 5A, FIG. 5B, FIG. 5C, and FIG. 5D are schematic top views illustrating an example of the configuration of the maintenance unit.

FIG. 6 is a flowchart of a start-up processing operation of the printing apparatus.

FIG. 7 is a flowchart showing details of a shortening initialization operation.

FIG. 8 is a flowchart showing details of an overall initialization operation.

FIG. 9 is a flowchart showing details of a conveyance mechanism initialization operation.

FIG. 10 is a flowchart showing details of a cutter unit initialization operation.

FIG. 11 is a flowchart showing details of a roll paper retraction operation.

FIG. 12 is a flowchart showing details of a paper feeding operation.

### DESCRIPTION OF THE EMBODIMENTS

Hereinafter, embodiments will be described in detail with reference to the attached drawings. Note, the following embodiments are not intended to limit the scope of the claimed disclosure. Multiple features are described in the embodiments, but limitation is not made to a disclosure that requires all such features, and multiple such features may be combined as appropriate. Furthermore, in the attached drawings, the same reference numerals are given to the same or similar configurations, and redundant description thereof is omitted.

### Overall Configuration of Printing Apparatus

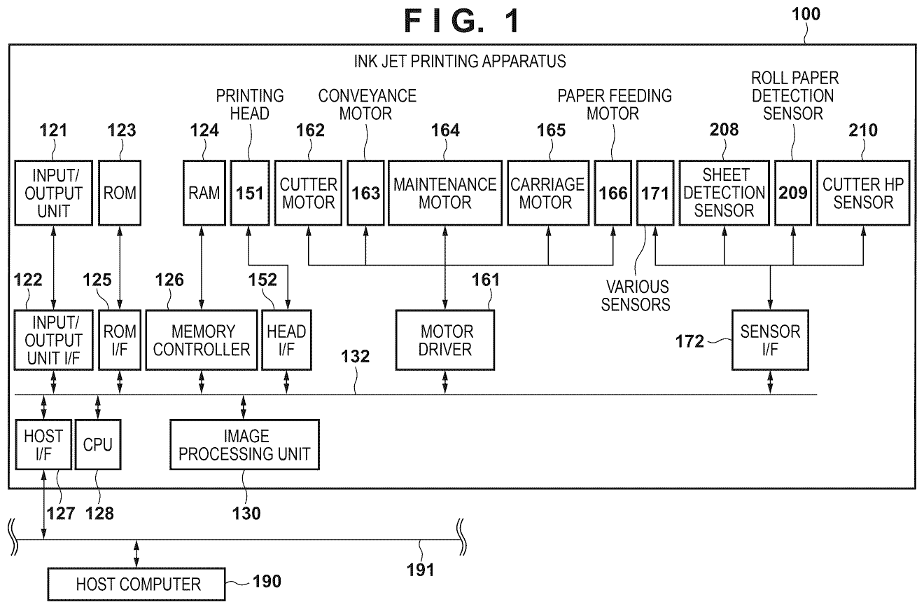

FIG. 1 is a block diagram illustrating an example of a system configuration of a printing apparatus 100 according to an embodiment. In the present embodiment, the printing apparatus 100 is an ink jet printing apparatus that performs printing by ejecting ink onto a sheet-like printing medium such as a paper material to form an image on the printing medium. The concept of the image here includes characters, numbers, symbols, figures, and photographs, and also includes a blank formed therebetween.

FIG. 1 illustrates only elements related to the print function of the printing apparatus 100, but the configuration of the printing apparatus 100 is not limited to the present example. For example, the printing apparatus 100 may further include an image reading function of reading an image of a document. Alternatively, the printing apparatus 100 may be a multifunction peripheral (MFP) further having various functions such as a facsimile function.

The printing apparatus 100 includes an input/output unit 121, an input/output unit interface (I/F) 122, a read only memory (ROM) 123, a random access memory (RAM) 124, a ROM interface 125, a memory controller 126, a host interface 127, a central processing unit (CPU) 128, and an image processing unit 130. The printing apparatus 100 further includes a printing head 151 and a head interface 152. The printing apparatus 100 further includes a motor driver 161, a motor cutter 162, a conveyance motor 163, a maintenance motor 164, a carriage motor 165, and a paper feeding motor 166. The printing apparatus 100 further includes a sensor interface 172, a sheet detection sensor 208, a roll paper detection sensor 209, and a cutter home position (HP) sensor 210. In addition, the printing apparatus 100 further includes various sensors 171.

The above-described elements are directly/indirectly connected to one another via a system bus 132, and information (signal or data) necessary for execution of printing is exchanged among the elements.

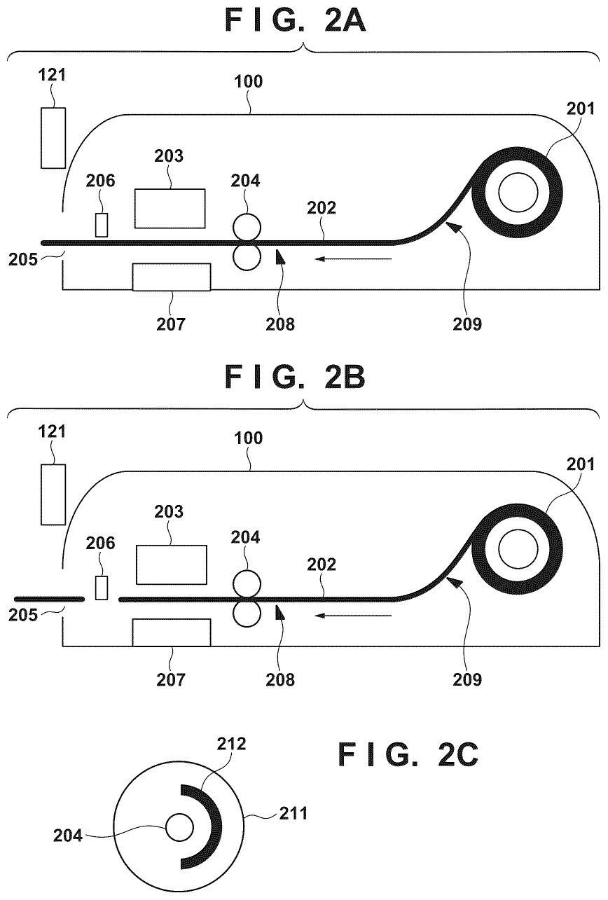

FIGS. 2A and 2B are schematic side views illustrating an example of the configuration of the printing apparatus 100. The printing apparatus 100 further includes a roll paper tube 201, a carriage 203, a conveyance roller 204, a sheet discharge port 205, a cutter unit 206, and a maintenance unit 207. In the present embodiment, a roll paper 202 having a long shape wound around the roll paper tube 201 is used as a printing medium.

The carriage 203 is configured to be able to move back and forth in a predetermined direction, and the printing head 151 is mounted on the carriage 203. The carriage 203 reciprocates based on the power of the carriage motor 165, thereby causing the printing head 151 to scan. The conveyance roller 204 conveys the roll paper 202 based on the power of the conveyance motor 163. The conveyance direction of the roll paper 202 intersects (is substantially orthogonal to) the scanning direction of the printing head 151. The roll paper tube 201 rotates based on the power of the paper feeding motor 166 so as to cooperate with the conveyance motor 163, whereby the roll paper 202 is supplied to a conveyance path. The roll paper tube 201 can also reversely rotate based on the power of the paper feeding motor 166, and can also wind the roll paper 202 on the conveyance path.

The printing apparatus 100 is connected to a network 191 via the host interface 127, and receives a print job instructing execution of printing from a host computer 190 of an outside, for example. A printer driver corresponding to the printing apparatus 100 can be installed in the host computer 190. The host computer 190 may be a personal computer, but may be another electronic device such as an image reading reader, a digital camera, or a smartphone. Communication between the printing apparatus 100 and the host computer 190 may be performed by wire.

The CPU 128 reads, from the ROM 123, a program for executing printing, and executes the program on the RAM 124. The CPU 128 functions as a control unit that controls the entire system of the printing apparatus 100, and starts up hardware before execution of the program. For example, a flash ROM is used as the ROM 123, and the ROM 123 stores data necessary for drive control of each element in addition to a program executable by the CPU 128. For example, a dynamic RAM (DRAM) is used as the RAM 124, and the RAM 124 functions as a work area of the CPU 128 and temporarily stores data necessary for execution of printing, for example. The CPU 128 performs calculation processing based on the print job in this manner and performs drive control of each clement.

For example, the image processing unit 130 develops, into image data (bitmap data), print data (e.g., data expressed in a page description language) included in the print job. In addition, the image processing unit 130 converts a color space (e.g., YCbCr) of image data into a standard RGB color space (e.g., sRGB). Additionally, the image processing unit 130 can perform syntax analysis, resolution conversion to the number of effective pixels (the number of pixels that can be processed by the printing apparatus 100), image analysis, image correction, and the like on the converted image data. The image data obtained by image processing of the image processing unit 130 is stored in the RAM 124.

The printing head 151 can execute printing based on the image data during scan by reciprocation of the carriage 203 (scan printing). While the scan printing of the printing head 151 is being performed, conveyance of the roll paper 202 is suppressed, and the roll paper 202 is conveyed again (intermittent conveyance) after completion of the scan printing and before start of the next scan printing. That is, printing on the roll paper 202 is executed by alternately repeating intermittent conveyance of the roll paper 202 and scan printing of the printing head 151 (see FIG. 2A).

In the roll paper 202, a part having been recorded by the printing head 151 is cut to a predetermined length by the cutter motor 162 driving the cutter unit 206, and the cut part is output as a printed product (see FIG. 2B).

In the present embodiment, only the conveyance path of the roll paper 202 is illustrated, but a conveyance path for cut paper may be further provided.

The sheet detection sensor 208 is arranged on an upstream side of the conveyance roller 204, and the roll paper detection sensor 209 is arranged on a further upstream side thereof. The upstream side mentioned here refers to the roll paper tube 201 side in the conveyance path or the conveyance direction of the roll paper 202, and the opposite side is a downstream side.

The roll paper detection sensor 209 can detect existence or absence of the roll paper 202 supplied from the roll paper tube 201. A known optical sensor is used as the sensor 209, and the existence or absence of the roll paper 202 is detected based on blocking of light due to the existence of the roll paper 202. The sheet detection sensor 208 can detect existence or absence of a cut sheet in addition to the existence or absence of the roll paper 202, and can be configured similarly to the sensor 209.

Note that other known sensors, for example, mechanical sensors may be used as the sensor 208 and/or the sensor 209.

Information indicating the state in the printing apparatus 100 is acquired from a corresponding sensor via the sensor interface 172. For example, information indicating the position of the printing head 151 (the position of the carriage 203) is acquired based on the detection result of the sensor 171. For example, information indicating the position or the conveyance state of the roll paper 202 is acquired based on the detection result of the sensor 208 and/or the sensor 209.

The input/output unit 121 is configured to be able to receive an operation input from a user and to be able to output display of necessary information, and for example, a touch panel display is used as the input/output unit 121. The input function and the output function of the input/output unit 121 may be configured separately, and for example, a physical key and a display may be individually installed. A typical example of the operation input from the user is a print setting, and this print setting includes, for example, a setting of enabling/disabling of manual cutting. In addition, the output of the input/output unit 121 may be performed by sound such as a buzzer or a voice instead of display, or may be performed by lighting on or blinking of an LED.

As illustrated in FIGS. 2A and 2B, the input/output unit 121 is installed above the sheet discharge port 205, and the user can perform operation input of the printing apparatus 100, reception of a printed product, and the like on the input/output unit 121 side. As another embodiment, the input/output unit 121 may be an external electronic component or may be a part of the host computer 190.

### Maintenance Operation

As illustrated in FIGS. 2A and 2B, the maintenance unit 207 is installed at a position that can oppose the printing head 151 and the carriage 203, and can execute maintenance of the printing head 151. Although details will be described later, the maintenance motor 164 is used at the time of maintenance operation by the maintenance unit 207, and at that time, the operation of the maintenance unit 207 is switched by drive of the conveyance motor 163.

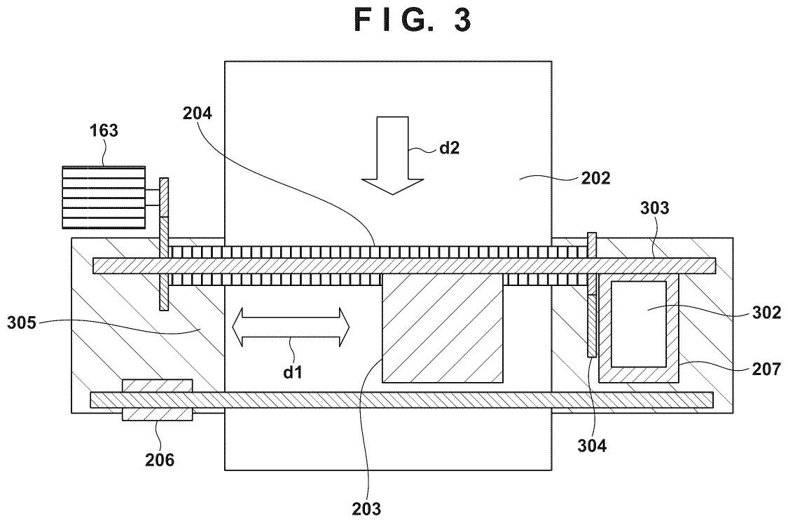

FIG. 3 is a schematic top view illustrating an example of an internal configuration of the printing apparatus 100. The carriage 203 mounted with the printing head 151 reciprocates along a guide rail 303 based on the power of the carriage motor 165, and can reciprocate in a direction d1 in the drawing. The conveyance roller 204 rotates based on the power of the conveyance motor 163, and conveys the roll paper 202 supported by a platen 305 in a d2 direction in the drawing. The cutter unit 206 cuts the roll paper 202 having been recorded on the downstream side of the printing head 151 and the carriage 203.

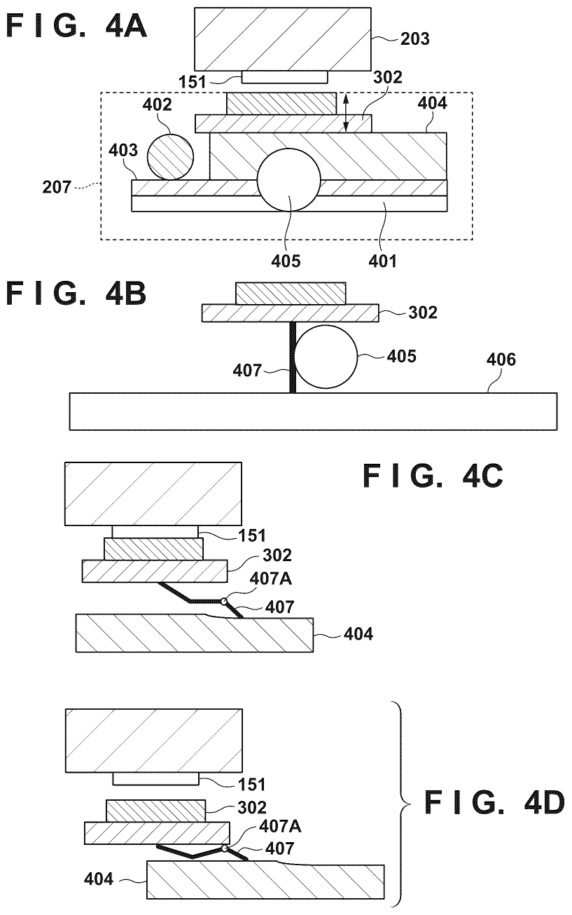

The maintenance unit 207 is installed on a lateral direction of the conveyance path of the roll paper 202, and the carriage 203 can move the printing head 151 to a position opposing the maintenance unit 207. The maintenance unit 207 can perform maintenance of the printing head 151 in this state. Although details will be described later, the maintenance unit 207 includes a cap 302 (see FIG. 4A and the like).

The conveyance motor 163 can rotate a gear 304 in contact with the maintenance unit 207 via the conveyance roller 204, and can switch the operation of the maintenance unit 207 via the gear 304 by the power of the conveyance motor 163.

FIG. 4A is a schematic side view illustrating an example of an internal configuration of the maintenance unit 207. The maintenance unit 207 includes a plate member 401, a gear 402, a guide 403, a guide 404, and a pump 405.

The cap 302 is installed above the maintenance unit 207, is movable up and down so as to cap the printing head 151 or release the capping, and evaporation of ink in the printing head 151 can be suppressed by capping. For example, when the roll paper 202 having been recorded is discharged, the printing head 151 is moved by the carriage 203 to a position opposing the cap 302, and then, is capped by the cap 302 rising.

In addition, the printing head 151 can also eject ink without raising (without capping) the cap 302 in a state of opposing the cap 302, that is, perform what is called pre-ejection. By periodically repeating this pre-ejection, it is possible to suppress evaporation of ink in the printing head 151 also in a non-capped state.

As illustrated in FIG. 4B, the cap 302 is connected to a waste ink absorber 406 via a tube 407. In a state where the printing head 151 is capped, the waste ink received by the cap 302 can be discharged to the waste ink absorber 406 via the tube 407 by driving the pump 405 based on the power of the maintenance motor 164. In a case of driving the pump 405 in a state where the printing head 151 is not capped, it is possible to perform an idle suction operation in which a waste ink collector 406 collects the ink ejected to the cap 302.

With reference to FIG. 4A again, the plate member 401 is movable in the left-right direction in the drawing together with the guide 403 engaged with the gear 402 by rotation of the gear 402. Such a configuration can switch the maintenance operations by the maintenance unit 207 such as capping and an idle suction operation.

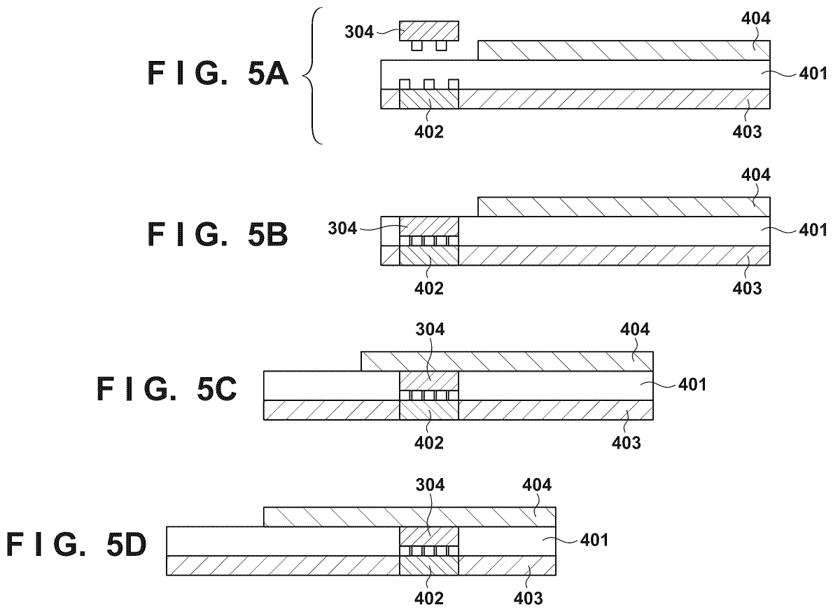

FIGS. 5A to 5D are schematic diagrams for describing the configuration of the maintenance unit 207 from other viewpoints.

FIG. 5A illustrates a state where the gear 402 is engaged with the guide 403 thereon. In this state, the gear 304 is disposed on a lateral direction of the gear 402 and at a position opposing the gear 402. The gear 304 can rotate in synchronization with the conveyance roller 204 based on the power of the conveyance motor 163. In FIG. 5A, the gear 402 and the gear 304 are separated from each other, and even when the conveyance roller 204 rotates, the gear 402 does not rotate and the plate member 401 does not move.

While the roll paper 202 exists on the conveyance roller 204, the gear 402 and the gear 304 are maintained in a state of being separated from each other, and the movement of the plate member 401 is suppressed to maintain a state in which the maintenance operation is not performed. By this, for example, even if the electric power is cut off when the roll paper 202 exists on the conveyance roller 204 and the user manually rotates the conveyance roller 204, the maintenance unit 207 is not damaged.

On the other hand, at the time of executing the maintenance operation, as illustrated in FIG. 5B, the gear 402 and the gear 304 are engaged by joining them on the side surfaces thereof, and the gear 402 is made rotatable based on the power of the conveyance motor 163. For example, when the carriage 203 stops at a predetermined position, joining of the gear 402 and the gear 304 is realized by engaging the gear 304 with the gear 402 by pushing the gear 304 to the gear 402 side. When the conveyance motor 163 is driven in this state, the plate member 401 moves in the left-right direction in the drawing.

As illustrated in FIG. 5C, the guide 404 fixes the gear 304 by the movement of the plate member 401, and maintains the gear 304 in a state of being pressed to the gear 402 side. Accordingly, during the maintenance operation, the plate member 401 is maintained in a movable state by the drive of the conveyance motor 163.

On the other hand, after the maintenance operation ends, the gear 402 and the gear 304 are returned to the state of being separated from each other (the state of FIG. 5A), whereby they are disengaged, and brought into a state where the maintenance operation is not performed even if the conveyance roller 204 rotates. The separation between the gear 402 and the gear 304 is realized, for example, by moving the plate member 401 to the position of FIG. 5A at a position where the carriage 203 does not push the gear 304 to the gear 402 side.

In the present embodiment, when the pump 405 is driven based on the power of the maintenance motor 164 in a state where the plate member 401 is moved to the position of FIG. 5C, the idle suction operation is performed, and the ink received by the cap 302 is collected by the waste ink collector 406. In addition, when the cap 302 is raised in a state where the plate member 401 is moved to the position of FIG. 5D, the printing head 151 can be capped.

As illustrated in FIGS. 4C and 4D, a cap arm 407 having a shaft 407A as a rotation axis is disposed between the cap 302 and the guide 404, and the cap 302 is supported by the cap arm 407. A height difference is formed on a surface of the guide 404 on the cap arm 407 side.

For example, in the state of FIG. 4C, the cap arm 407 abuts on a surface that is low in height of the guide 404 and raises the cap 302. This can cap the printing head 151. In addition, in the state of FIG. 4D, the cap arm 407 abuts on the surface that is high in height of the guide 404 and lowers the cap 302. This can decap the printing head 151.

That is, when the position of the guide 404 changes, the attitude of the cap arm 407 changes, thereby moving the cap 302 up and down. Note that the height difference of the guide 404 may be connected by a curved surface or may be connected by an inclined surface.

### Start-Up Processing Operation of Printing Apparatus

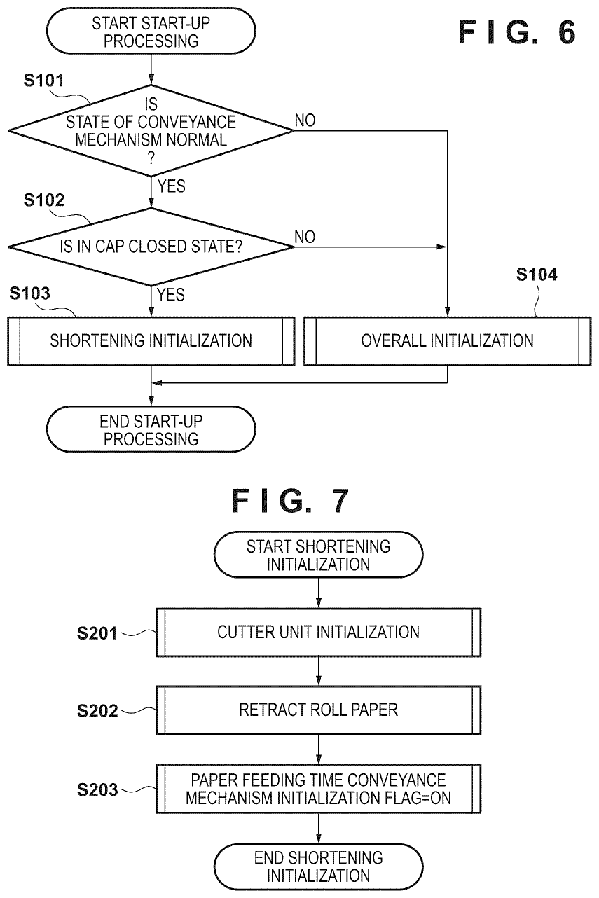

FIG. 6 shows a flowchart of a start-up processing operation performed when the printing apparatus 100 is powered on. The present flowchart is executed mainly by the CPU 128.

In step S101 (hereinafter, simply called “S101”. The same applies to other steps described later). The CPU 128 determines whether or not the state of the conveyance mechanism is normal. In the present embodiment, the present determination is made based on an in-conveyance path sheet existence/absence flag in addition to the detection result of the sheet detection sensor 208. The in-conveyance path sheet existence/absence flag is stored in the ROM 123. For example, at the timing when the roll paper 202 is supplied to the conveyance path or discharged from the conveyance path, the in-conveyance path sheet existence/absence flag is stored in the ROM 123 as information indicating existence or absence of the roll paper 202 in the conveyance path.

In this manner, when the sheet detection sensor 208 detects that no roll paper 202 exists in the conveyance path and the in-conveyance path sheet existence/absence flag indicates that no roll paper 202 exists in the conveyance path, the state of the conveyance mechanism is determined to be normal. If it is determined that the state of the conveyance mechanism is normal, the process proceeds to S102, and otherwise, the process proceeds to S104.

In S102, the CPU 128 determines whether or not the printing head 151 is in a cap closed state capped by the cap 302. In the present determination, a cap state flag indicating the state of the cap 302 is used. The cap state flag is stored in the ROM 123. For example, the cap state flag is stored in the ROM 123 as information indicating any of an operation of capping the printing head 151 with the cap 302 (cap close operation) and an operation of decapping (cap open operation) at the time of the operation of capping or the operation of decapping.

If it is determined as the cap closed state, the process proceeds to S103, and otherwise, the process proceeds to S104.

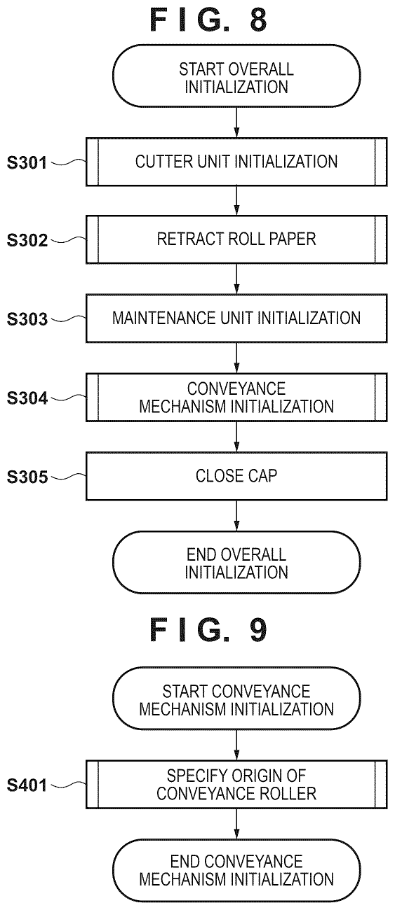

The CPU 128 executes the shortening initialization operation described later in S103 (see FIG. 7), or executes an overall initialization operation described later in S104 (see FIG. 8), and then ends the present flowchart.

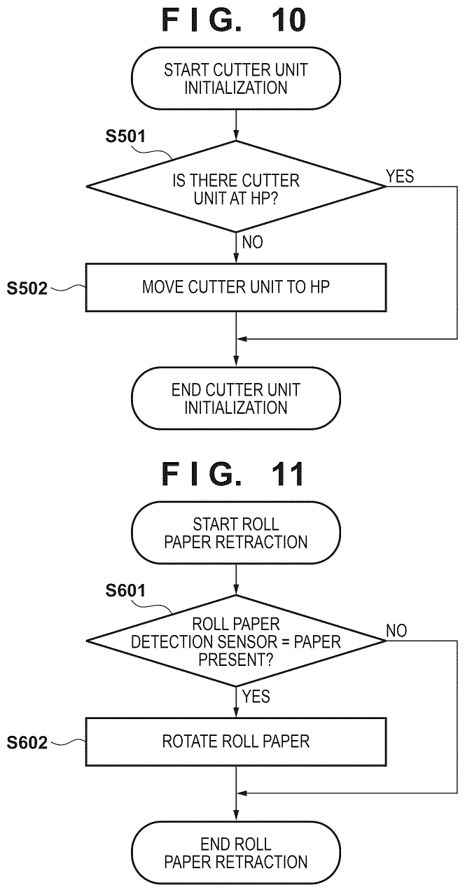

FIG. 7 is a flowchart showing details of the shortening initialization operation of S103. The CPU 128 executes the cutter unit initialization operation described later in S201 (see FIG. 10), and executes the roll paper retraction operation described later in S202 (see FIG. 11).

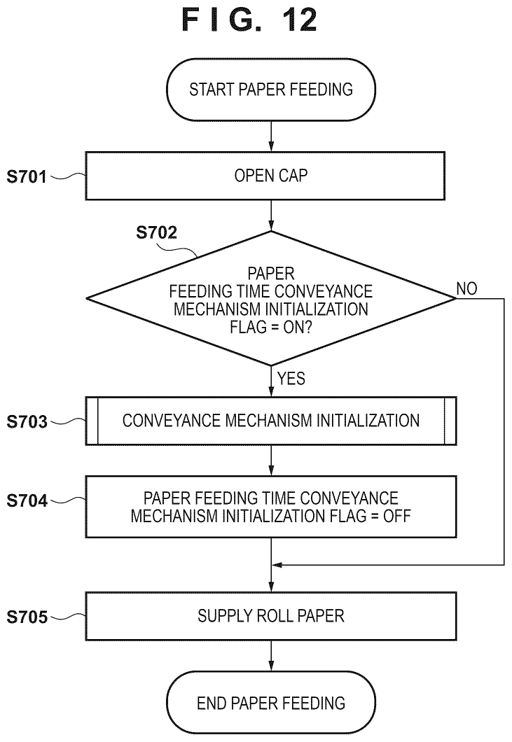

In S203, the CPU 128 sets a paper feeding time conveyance mechanism initialization flag to ON. The paper feeding time conveyance mechanism initialization flag is a flag for deciding whether or not to execute initialization of the conveyance mechanism in a paper feeding operation (see FIG. 12) described later for supplying the roll paper 202.

FIG. 8 is a flowchart showing details of the overall initialization operation in S104. The CPU 128 executes the cutter unit initialization operation described later in S301 (see FIG. 10), and executes the roll paper retraction operation described later in S302 (see FIG. 11).

In S303, the CPU 128 executes a maintenance unit initialization operation for initializing the maintenance unit 207. In the maintenance unit initialization operation of the present embodiment, in addition to the cap open operation described above, an operation of initializing the position of the carriage 203 and an operation of initializing the position of the plate member 401 are performed. After S303, the gear 402 and the gear 304 are separated from each other (see FIG. 5A), and the conveyance roller 204 is brought into a freely rotatable state without being affected by the maintenance unit 207.

The CPU 128 executes the conveyance mechanism initialization operation described later in S304 (see FIG. 9), executes the cap close operation described above in S305, and then ends the present flowchart.

FIG. 9 is a flowchart showing details of the conveyance mechanism initialization operation in S304. The conveyance mechanism initialization operation is performed in a state where the gear 402 and the gear 304 are separated from each other and the conveyance roller 204 is freely rotatable without being affected by the maintenance unit 207.

In S401, the CPU 128 executes an origin specification operation for specifying the origin of the conveyance roller 204. The conveyance amount of the roll paper 202 is controlled by a conveyance encoder (not illustrated) that detects the rotation amount of the conveyance roller 204, and therefore when the conveyance roller 204 is eccentric, an error occurs in the conveyance amount due to the angle/phase of the conveyance roller 204. The conveyance error caused by the eccentricity of the conveyance roller 204 is corrected based on the angle/phase of the conveyance roller 204 (eccentricity correction). The origin of the conveyance roller corresponds to a reference point or a start point of the angle/phase of the conveyance roller 204, and is used to perform this eccentricity correction.

In the present embodiment, as illustrated in FIG. 2C, the conveyance roller 204 includes a conveyance encoder wheel 211 and a mark 212 formed thereon. The mark 212 indicates the origin position of the conveyance roller 204. When the conveyance roller 204 rotates based on the drive of the conveyance motor 163, by detecting the mark 212 using a predetermined sensor, it is possible to specify the origin of the conveyance roller 204. In the origin specification operation of the conveyance roller 204, when the conveyance roller 204 is rotated, a position where an output signal of the sensor that detects the mark 212 changes from a low level to a high level, for example, can be specified as the origin of the conveyance roller 204.

FIG. 10 is a flowchart showing details of the cutter unit initialization operation in S201 and S301.

In S501, the CPU 128 determines whether or not the cutter unit 206 is positioned at the cutter HP. The present determination is made based on the detection result of the cutter HP sensor 210. For example, a photointerrupter can be used as the cutter HP sensor 210. If it is determined that the cutter unit 206 is positioned at the cutter HP, the present flowchart ends, and otherwise, the process proceeds to S502.

In S502, the CPU 128 moves the cutter unit 206 to the cutter HP based on the power of the cutter motor 162, and ends the present flowchart.

FIG. 11 is a flowchart showing details of the roll paper retraction operation in S202 and S302.

In S601, the CPU 128 determines whether or not the roll paper 202 exists at the position of the roll paper detection sensor 209. If it is determined that the roll paper 202 exists at the position of the roll paper detection sensor 209, the process proceeds to S602, and otherwise, the present flowchart ends.

In S602, the CPU 128 reversely rotates the roll paper tube 201 based on the power of the paper feeding motor 166 and rewinds the leading end (downstream side end) of the roll paper 202 to the point before the roll paper detection sensor 209, thereby retracting the roll paper 202. This is realized, for example, by reversely rotating the roll paper tube 201 further by a predetermined amount after the roll paper detection sensor 209 detects that no roll paper 202 exists, and moving the leading end of the roll paper 202 to a predetermined position.

FIG. 12 is a flowchart showing details of the paper feeding operation for supplying the roll paper 202.

In S701, the CPU 128 executes the cap open operation, and lowers the cap 302 to decap the printing head 151. Thereafter, the CPU 128 further performs an operation of initializing the position of the carriage 203. After S701, the gear 402 and the gear 304 are separated from each other, and the conveyance roller 204 is brought into a freely rotatable state without being affected by the maintenance unit 207.

In S702, the CPU 128 determines whether or not the paper feeding time conveyance mechanism initialization flag is ON. As described with reference to S203 of FIG. 7, the paper feeding time conveyance mechanism initialization flag is set to ON when the shortening initialization operation is executed. If the paper feeding time conveyance mechanism initialization flag is ON, the process proceeds to S703, and otherwise, the process proceeds to S705.

In S703, the CPU 128 executes the conveyance mechanism initialization operation described above (sec FIG. 9).

In S704, the CPU 128 sets the paper feeding time conveyance mechanism initialization flag to OFF. By setting the paper feeding time conveyance mechanism initialization flag to OFF, the conveyance mechanism initialization operation in S703 is not executed again in the subsequent paper feeding operation.

By this, after the shortening initialization operation is executed, the conveyance mechanism initialization operation is executed only at the time of the first paper feeding operation. Therefore, after the shortening initialization operation is executed, the time required for the paper feeding operation is lengthened, for example, by about several seconds, only at the time of the first paper feeding operation.

In S705, the CPU 128 executes the paper feeding operation, that is, supplies and conveys the roll paper 202 by rotating the roll paper tube 201 and the conveyance roller 204 based on the power of the paper feeding motor 166 and the conveyance motor 163. At this time, after the position of the leading end of the roll paper 202 is detected by the sheet detection sensor 208, the roll paper 202 is conveyed by a predetermined amount.

The position at the time of completion of the conveyance corresponds to a waiting position before the start of printing.

According to the present embodiment, as seen from a comparison between the shortening initialization operation of FIG. 7 and the overall initialization operation of FIG. 8, the shortening initialization operation does not include the maintenance unit initialization operation of S303.

In the start-up processing operation of FIG. 6, the determination of S101 (the determination of whether or not the state of the conveyance mechanism is normal) and the determination of S102 (the determination of whether or not the conveyance mechanism is in the cap closed state) are performed. Therefore, in a case of Yes determination in both S101 and S102, it is guaranteed that each mechanism such as the maintenance unit 207 and the carriage 203 is at a predetermined position at the time of previous/immediately preceding power off. Therefore, in such a case, the shortening initialization operation is performed.

When the shortening initialization operation is performed, the conveyance mechanism initialization operation is performed in S703 during the paper feeding operation, and is not performed in the shortening initialization operation. That is, in the case of the shortening initialization operation, a part of the initialization is omitted, and the required time is shortened as compared with the overall initialization operation by, for example, about several tens of seconds. In addition, the name of each operation may be generalized, for example, the overall initialization operation may be expressed as a first initialization operation, and the shortening initialization operation may be expressed as a second initialization operation.

### Program

The present disclosure may be realized by preliminarily supplying a program for realizing one or more functions of the aforementioned embodiments to a system or an apparatus via a network or a storage medium, and performing a process that causes one or more processors included in a computer of the system or the apparatus to read and execute the program. Furthermore, the present disclosure can also be realized by a circuit (e.g., an ASIC) that realizes one or more functions.

### Addendum

Individual components in the foregoing embodiments are named using expressions based on their main functions, the functions mentioned in the embodiments may be sub-functions and the nomenclature is not strictly limited to such expressions. In addition, the expression can be replaced with another similar expression. For the same purpose, the expressions “unit” and “portion” can be replaced with “tool”, “component”, “member”, “structure”, “assembly”, or the like. Alternatively, those expressions may be omitted or attached.

In addition, in the embodiments, the printing apparatus 100 that performs printing by the ink jet method has been exemplified, but the ink can be interpreted in a broad sense, and the concept thereof can include various liquids such as a colorless and transparent reaction liquid. For the same purpose, the printing apparatus 100 can include a liquid ejection apparatus, and the printing head 151 may include a liquid ejection head.

In addition, two or more elements exemplarily described as selectable in the embodiment are not strictly limited to the description and may be combined as desired. For example, each of the two or more elements exemplarily described as selectable may be additionally selected or alternatively selected. As an example, when two elements A and B are combined as desired, the expression “A and/or B” or the expression “at least one of A and B” may be used to indicate any one of A only, B only, or both A and B.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-095375, filed Jun. 12, 2024, which is hereby incorporated by reference herein in its entirety.

What is claimed is:

1. A printing apparatus comprising:
a printing head that performs printing on a printing medium;
a conveyance mechanism that conveys a printing medium;
a maintenance unit that executes a maintenance operation for the printing head, the maintenance unit being configured to be able to receive power in the conveyance mechanism and to be able to perform the maintenance operation based on the received power; and
a control unit configured to determine existence or absence of a printing medium in the conveyance mechanism and a state of the maintenance unit when the printing apparatus is started up, and decides permission/inhibition of execution of a first initialization operation of initializing the conveyance mechanism and the maintenance unit based on a result of the determination.

2. The printing apparatus according to claim 1, wherein the control unit executes the first initialization operation when a printing medium exists in the conveyance mechanism or the maintenance unit is not in an initial state, and
does not execute the first initialization operation, and executes initialization of the conveyance mechanism at a time of a first paper feeding operation after start-up of the printing apparatus when no printing medium exists in the conveyance mechanism and the maintenance unit is in the initial state.

3. The printing apparatus according to claim 2, wherein the control unit does not initialize the maintenance unit when no printing medium exists in the conveyance mechanism and the maintenance unit is in the initial state.

4. The printing apparatus according to claim 1, wherein the conveyance mechanism includes a conveyance roller and a first gear that rotates together with the conveyance roller, and
the maintenance unit includes a second gear engageable with the first gear, and receives the power from the conveyance mechanism by the second gear being engaged with the first gear.

5. The printing apparatus according to claim 4, further comprising:
a carriage that is mounted with the printing head and reciprocates so as to scan the printing head in a direction intersecting a conveyance direction of the printing medium by the conveyance mechanism,
wherein the carriage engages the second gear with the first gear by the reciprocation.

6. The printing apparatus according to claim 4, wherein initialization of the conveyance mechanism includes specifying an origin of the conveyance roller.

7. The printing apparatus according to claim 1, wherein the printing medium is roll paper, the printing apparatus further includes a cutter unit for cutting the roll paper, and
the control unit initializes the cutter unit regardless of existence or absence of a printing medium in the conveyance mechanism and a state of the maintenance unit.

8. The printing apparatus according to claim 7, wherein the control unit retracts the roll paper to a predetermined position regardless of existence or absence of a printing medium in the conveyance mechanism and a state of the maintenance unit.

9. The printing apparatus according to claim 1, wherein the maintenance unit includes a cap for capping the printing head, the printing apparatus further includes
a sensor for detecting existence or absence of a printing medium in the conveyance mechanism, and
a storage unit that stores first information indicating existence or absence of a printing medium in the conveyance mechanism and second information indicating a state of the cap, and
the control unit performs the determination based on a detection result of the sensor and the first information and the second information stored in the storage unit.

10. A control method for a printing apparatus, the printing apparatus comprising a printing head that performs printing on a printing medium, a conveyance mechanism that conveys a printing medium, and a maintenance unit that executes a maintenance operation for the printing head, wherein the maintenance unit is configured to be able to receive power in the conveyance mechanism and to be able to perform the maintenance operation based on the received power, and the control method comprising:
determining existence or absence of a printing medium in the conveyance mechanism and a state of the maintenance unit when the printing apparatus is started up, and
deciding permission/inhibition of execution of a first initialization operation of initializing the conveyance mechanism and the maintenance unit based on a result of the determination.

11. A non-transitory computer-readable storage medium storing a program configured to cause a computer to execute control method according to claim 10.
